(19) United States
(12) Patent Application Publication
(10) Pub. No.: US 2016/0200079 A1
(43) Pub. Date: Jul. 14, 2016

(54) MULTI-LAYER SHEET MATERIAL AND METHOD FOR THE PRODUCTION THEREOF

(71) Applicant: BENECKE-KALIKO AG, Hannover (DE)

(72) Inventors: Dirk Mielke, Hemmingen (DE); Roland Freudenmann, Wedemark (DE); Michael van Well, Garbsen (DE); Jürgen Bühring, Wedemark (DE)

(21) Appl. No.: 14/915,108

(22) PCT Filed: Jul. 9, 2014
(86) PCT No.: PCT/EP2014/064662

§ 371 Date: Feb. 26, 2016

(30) Foreign Application Priority Data
Aug. 29, 2013 (DE) 10 2013 109 408.2

(51) Int. Cl. B32B 27/30; B60R 13/02; B32B 37/14; B32B 5/18; B32B 3/30

(52) U.S. Cl. CPC B32B 27/304; B32B 5/18; B32B 3/30; B32B 37/14; B60R 13/02; B32B 2255/10; B32B 2255/26; B32B 2266/0214; B32B 2605/003

(57) ABSTRACT

A multi-layer sheet material having at least one topcoat layer of plasticized polyvinyl chloride and at least one outwardly facing layer of lacquer on the topcoat layer, where the topcoat layer of the multi-layer sheet material contains from 50 to 100 wt % of at least one polyvinyl chloride and from 0 to 15 wt % of at least one crosslinking aid suitable for radiation crosslinking, and a calcium hydroxide stabilizer and/or a Ca/Zn stabilizer having from 0.5 to 10 wt % of calcium and from 0.5 to 10 wt % of zinc. The multi-layer sheet material is radiation crosslinked.

### CROSS REFERENCE TO RELATED APPLICATIONS

This application is a continuation application of international patent application PCT/EP2014/064662, filed Jul. 9, 2014, designating the United States and claiming priority from German application 10 2013 109 408.2, filed Aug. 29, 2013, and the entire content of both applications is incorporated herein by reference.

### FIELD OF THE INVENTION

The invention relates to a multi-layer sheet material having at least one topcoat layer of plasticized polyvinyl chloride and at least one outwardly facing layer of lacquer on the topcoat layer. The invention further relates to a method of producing the multi-layer sheet material and also to a vehicle interior trim component consisting of a sheet material.

### BACKGROUND

This section provides background information to facilitate a better understanding of the various aspects of the disclosure. It should be understood that the statements in this section of this document are to be read in this light, and not as admissions of prior art.

Sheet materials in plasticized polyvinyl chloride (PVC) with further polymeric layers underneath, which are often foamed, are already known for the interior trimming of motor vehicles as surfaces for instrument panels, door panel trim, pillar trim, etc. The sheet materials typically have a multi-layer construction, are often laminated onto component parts or back-foamed, and on their face side they have a three-dimensionally textured, embossed surface, viz., a pattern or grain in a very wide variety of shapes and forms. The multi-layer construction often consists of an upper, optionally lacquered topcoating or decorative layer, which is embossed, optionally a foamed layer and optionally a primer on the reverse side. The primer is there to improve bonding or foam adherence to the backing. Sheet materials of this type are described in WO2011091878A1 for example.

It is particularly for use of the sheet materials as interior trimming of motor vehicles that the grained sheet materials are thermoformed. However, thermo-forming causes some distortion of the grained surface, which is undesirable particularly in areas featuring high degrees of draw depth. In respect of sheet materials containing essentially polyolefins, it is already known, inter alia from EP1149858B1, that any distortion is reducible by subjecting the polyolefin-containing sheet material to radiation crosslinking. Radiation crosslinking could hitherto not be applied to PVC-containing decorative sheet materials because a secondary reaction in relation to the crosslinking reaction leads to some degradation of the PVC, causing in turn troublesome changes in color. It has accordingly hitherto not been possible to improve the thermoformability of sheet materials which contain a PVC foam layer or which represent of a laminate between a PVC layer and at least one further layer, for example in polypropylene or polyethylene.

### SUMMARY

Some aspects of the disclosure include a multi-layer sheet material having at least one topcoat layer of plasticized polyvinyl chloride and at least one outwardly facing layer of lacquer on the topcoat layer, where the topcoat layer of the multi-layer sheet material contains from 50 to 100 wt % of at least one polyvinyl chloride and from 0 to 15 wt % of at least one crosslinking aid suitable for radiation crosslinking, and a calcium hydroxide stabilizer and/or a Ca/Zn stabilizer having from 0.5 to 10 wt % of calcium and from 0.5 to 10 wt % of zinc. The multi-layer sheet material is radiation crosslinked. In some aspects, the polyvinyl chloride fraction in the topcoat layer is based on E-PVC and/or on MS-PVC. The amount of crosslinking aid may be in the range from 0.1 to 10 wt %. In some cases, the crosslinking aid is TMPTMA and/or TMPTA. Further, the multi-layer sheet material may contain at least one additional layer based on PVC and/or TPO, which may or may not be foamed. The multi-layer sheet material may be used for interior trim components for vehicles.

In another aspect of the disclosure, methods of producing a multi-layer sheet material include preparing a topcoat layer of plasticized polyvinyl chloride by a spread coating, calendering or extrusion process in a first step, providing layers of the multi-layer sheet material in at least one further step, combining the topcoat and layers of the multi-layer sheet material in at least one further step, lacquering and embossing the external surface of the topcoat layer in at least one further step, and radiation crosslinking the multi-layer sheet material by electron beam irradiation in a last step. In some cases, the electron beam irradiation of the last step is performed at an energy level between 10 and 100 kGy.

In yet other aspects, methods for producing a multi-layer sheet material include providing a topcoat layer containing from 50 to 100 wt % of at least one polyvinyl chloride, from 0 to 15 wt % of at least one crosslinking aid suitable for radiation crosslinking, and a calcium hydroxide stabilizer and/or a Ca/Zn stabilizer having from 0.5 to 10 wt % of calcium and from 0.5 to 10 wt % of zinc. Further layers of the multi-layer sheet material are provided, and the topcoat and the further layers of the multi-layer sheet material are combined. An external surface of the topcoat layer is lacquered and embossed, then the multi-layer sheet is radiation crosslinked. The topcoat layer may be provided by a spread coating, calendering or extrusion process. In some cases, radiation crosslinking of the multi-layer sheet material is performed by electron beam irradiation, and the electron beam irradiation may be performed at an energy level between 10 and 100 kGy.

### DETAILED DESCRIPTION

The following description of the variations is merely illustrative in nature and is in no way intended to limit the scope of the disclosure, its application, or uses. The description and examples are presented herein solely for the purpose of illustrating the various embodiments of the disclosure and should not be construed as a limitation to the scope and applicability of the disclosure. While the compositions of the present disclosure are described herein as including certain materials, it should be understood that the composition could optionally include two or more chemically different materials. In addition, the composition can also include some components other than the ones already cited. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a concentration or amount range listed or described as being useful, suitable, or the like, is intended that any and every concentration or amount within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all points within the range.

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

The problem addressed by some embodiments of the present invention is providing a multi-layer sheet material comprising plasticized polyvinyl chloride layers which is of the type referred to incipitly and which resolves the conflict between grain distortion of the surface during thermoforming and discoloration of the surface of the sheet material. The problem is solved, according to some embodiments of the invention, when the topcoat layer of the multi-layer sheet material contains from 50 to 100 wt % of at least one polyvinyl chloride and from 0 to 15 wt % of at least one crosslinking aid suitable for radiation crosslinking and a calcium hydroxide stabilizer and/or a Ca/Zn stabilizer having from 0.5 to 10 wt % of calcium and from 0.5 to 10 wt % of zinc, and in that the multi-layer sheet material is radiation crosslinked.

It surprisingly it has been found that the combination of a crosslinking aid for radiation crosslinking, the radiation crosslinking operation and a calcium hydroxide stabilizer and/or Ca/Zn stabilizer provides a multi-layer sheet material containing essentially PVC as topcoat layer a distinct minimization of grain distortion coupled with a low pronounced tendency to discolor.

The multi-layer sheet material may contain at least one additional layer based on polyvinyl chloride and/or at least one thermoplastic polyolefin (TPO). This additional layer is in one preferred embodiment a foamed, i.e. a foam layer.

By way of polymer, the invention uses PVC in the topcoat layer in amounts of 50 to 100 wt %. It is preferable for the topcoat layer to have 100 wt % of PVC as polymer.

The polyvinyl chloride may preferably be in the form of S-PVC, which is produced industrially by suspension polymerization, or of E-PVC, which is produced industrially by emulsion polymerization, or of M-PVC, which is produced by mass polymerization, or of MS-PVC, which is produced by the microsuspension process. The polyvinyl chlorides thus obtained are processed by extrusion, calendering, spread coating, blow molding, injection molding, compression molding or sintering, with plasticizer contents of 0 to 12% (unplasticized PVC, PVC-U), >12% (plasticized PVC, PVC-P, PPVC) or at a very high level (plastisols, PVC paste). It is similarly also possible to use for example chlorinated PVC (PVC-C, PVCC) having a chlorine content of up to 73%. PVC-C has enhanced solubility and so is particularly resistant to chemicals and at the same time very highly resistant to heat. Of similar suitability are copolymers of vinyl chloride (VC), for example copolymers of VC and from 2 to 15% of vinyl acetate (VC/VAC), VC and 14% of vinyl acetate and 1% of maleic acid, VC and from 12 to 20% of vinylidene chloride and 1% of acrylonitrile, and also VC/E (vinyl chloride-ethylene), VC/E/MA (vinyl chloride-ethylene-methyl acrylate), VC/E/VAC (vinyl chloride-ethylene-vinyl acetate), VC/MA (vinyl chloride-methyl acrylate), VC/MMA (vinyl chloride-methyl methacrylate), VC/OA (vinyl chloride-octyl acrylate, VC/VAC (vinyl chloride-vinyl acetate) and VC/VDC (vinyl chloride-vinylidene chloride).

The topcoat layer of the multi-layer sheet material may contain from 0 to 50 wt % of at least one further plastic other than PVC. Any plastic known to a person skilled in the art can be used, in which case the composition is selected according to the type of use planned for the multi-layer sheet material and particularly the viscosity. The plastic in question may be, for example, ABS (acrylonitrile-butadiene-styrene copolymers), AMMA (acrylonitrile-methyl methacrylate), CA (cellulose acetate), CAB (cellulose acetobutyrate), CF (cresol-formaldehyde resins, cresol resins), CMC (carboxymethylcellulose), CSF (casein plastics), DAP (diallyl phthalate), EC (ethylcellulose), EP (epoxy resins), EPS (expandable polystyrene), EVA (ethylene-vinyl acetate copolymers), EVAL (ethylene-vinyl alcohol copolymers), FEP (perfluoroethylenepropylene), MBS (methyl methacrylate/butadiene/styrene copolymers), MC (methylcellulose), MF (melamine-formaldehyde resins), PA (polyamides), nylon 6 (poly(E-caprolactam)s), nylon 66 (polycondensate formed from hexane-1,6-diamine and adipic acid), PAN (polyacrylonitriles), PB (polybutenes), PBTP (polybutylene terephthalates), PC (polycarbonates), PCTFE (poly(chlorotrifluoro-ethylene)s), PE (polyethylenes), PEC (chlorinated polyethylene), PE-HD (high density polyethylene), PE-LD (low density polyethylene), PEP (ethylene-propylene copolymers), PETP (polyethylene terephthalates), PF (phenolic resins), PI (polyimides), PIB (polyisobutenes), PMMA (polymethyl methacrylate), POM (polyoxymethylenes), PP (polypropylenes), PPO (poly-phenylene oxides), PPS (polyphenylene sulfides), PS (polystyrene), PTFE (polytetrafluoroethylenes), PUR (polyurethanes), PVAC (polyvinyl acetates), PVAL (poly-vinyl alcohols), PVDC (polyvinylidene chlorides), PVDF (polyvinylidene fluorides), PVK (polyvinylcarbazoles), PVP (polyvinylpyrrolidones), SAN (styrene-acrylonitrile copolymers), SB (styrene-butadiene copolymers), SI (poly(dimethylsiloxanes)), SMS (copolymers formed from styrene and α-methylstyrene), UF (urea-formaldehyde resins), UP (unsaturated polyesters).

The PVC fraction of the composition for the topcoat layer is thus preferably based on E-PVC and/or MS-PVC at not less than 50 wt %, while the remaining PVC fraction may be formed by S-PVC. Preferably, however, the PVC fraction of the topcoat layer is based on E-PVC and/or on MS-PVC to an extent of not less than 75 wt % and more preferably to an extent of not less than 95 wt %, because this results in processing advantages for spread coating and/or calendering the topcoat layer and advantages in the thermal stability. By way of stabilizers, the topcoat layer contains at least one calcium hydroxide stabilizer and/or at least one specific Ca/Zn stabilizer. Said Ca/Zn stabilizer is a metal soap stabilizer having from 0.5 to 10 wt % of calcium and from 0.5 to 10 wt % of zinc, preferably from 0.5 to 5 wt % of calcium and from 0.5 to 5 wt % of zinc and more preferably from 1 to 3 wt % of calcium and from 1 to 2 wt % of zinc. To further improve the color stability, the use of at least one perchlorate as further stabilizer may be advantageous. Any perchlorates known to a person skilled in the art can be used, while sodium perchlorate is particularly suitable.

When the composition for the topcoat layer contains a Ca/Zn stabilizer, the weight ratio of calcium plus zinc from the Ca/Zn stabilizer to perchlorate in the composition for the topcoat layer in one advantageous refinement of the invention is in the range from 1:0.5 to 1:10, preferably from 1:1 to 1:6. Below these ratios, amine resistance gets worse and increased discoloration during heat-aging is observed. Excessive amounts of stabilizer add to the cost of the sheet material without providing additional benefits, and in some instances lead to poorer thermal stability.

When the composition for the topcoat layer contains calcium hydroxide as stabilizer, the weight ratio of calcium hydroxide stabilizer, i.e., Ca(OH)₂, to perchlorate in the composition for the topcoat layer is in the range from 20:1 to 1:1, preferably from 8:1 to 14:1.

In addition to the recited stabilizers, the composition for the topcoat layer may also contain further PVC stabilizers as known to a person skilled in the art, in customary amounts. These stabilizers include carbon-acid compounds (such as β-diketones, dihydropyridines, acetylacetonates), antioxidants (such as hindered phenols, sterically hindered amines), polyols, hydrotalcites, zeolites or organic stabilizers.

The PVC layers in the sheet materials contain not only plasticizers and stabilizers but also the customary additives such as, for example, aging control agents (e.g., antioxidants), fillers, flame retardants (e.g., antimony trioxide), blowing agents (e.g., azodicarbonamide), pigments (e.g., carbon black, titanium dioxide) and further auxiliaries (e.g., viscosity modifiers, adhesion promoters, etc.).

The multi-layer sheet material further has an outwardly facing layer of lacquer applied atop the topcoat layer. Useful lacquers include lacquers used on the basis of polyurethane (PU or PUR), PVC/acrylate, acrylate, as presented by Dr. Iben at the SKZ conference on pastes in Würzburg, Germany on Sep. 27, 2001. The application methods were also described there. The multi-layer sheet material preferably has a lacquer layer containing polyurethane and/or polyvinyl chloride/acrylate. Said lacquer layer ensures improved abrasion properties and a high level of resistance to suntan lotion. Said lacquers can further be used to establish antisqueak properties. Dispersion-based, i.e., waterborne, lacquers are particularly advantageous for compliance with the low VDA 278 emission mandates of VOC 100 ppm.

According to embodiments of the present invention, particularly with a view to reducing grain distortion, the topcoat layer contains from 0 to 15 wt % of at least one radiation crosslinking aid, and that the multi-layer sheet material be radiation crosslinked. Reduced grain distortion is even observable when the amount of radiation crosslinking aid is very low, i.e., from 0.1 to 1 wt %, or 0 wt %. The amount of radiation crosslinking aid is preferably in the range from 0.1 to 15 wt % and more preferably in the range from 1 to 5 wt %. Any radiation crosslinking aid known to a person skilled in the art is usable. It is particularly advantageous for the radiation crosslinking aid to be selected from the group containing trimethylolpropane trimethacrylate (TMPTMA) and/or trimethylolpropane triacrylate TMPTA and/or triallyl isocyanurate (TRIC) and/or pentaerythritol tetraacrylate and/or pentaerythritol triacrylate (PETA) and/or pentaerythrityl triallyl ether (PETAE) and/or highly ethoxylated trimethylpropane triacrylate and/or aliphatic urethane acrylate and/or hexafunctional aliphatic urethane acrylate and/or polyester resin comprising 40% of hexanediol diacrylate and/or epoxidized soybean oil acrylate and/or polyester acrylates, in particular polyester tetraacrylate. The use of TMPTMA and/or TMPTA is very particularly advantageous here, however.

As already mentioned above, it is similarly important that the multi-layer sheet material should be radiation crosslinked. The effect of the radiation crosslinking is to produce a bond between the long macromolecular chains in thermoplastics. This happens because the energy of the radiation used is absorbed in the plastic to form free radicals, which in turn produce the bond between the molecular chains via a chemical reaction. This crosslinking binds the molecules together and greatly constrains their mobility. The result is to convert the plastic into a thermoset and/or thermoelastic state. It has substantial dimensional stability even on elevated heating and is no longer fusible. The degree of crosslinking may be controlled via the energy introduced during the radiation crosslinking. Electron beam accelerators can be used for this at different power levels (electron beam radiation or beta radiation), or else cobalt 60 sources (gamma rays), in which case no radioactivity can be generated by the ionizing radiation in plastics for physical reasons.

The use of electron beam radiation is advantageous for crosslinking the multi-layer sheet material of the invention. Using electron beam accelerators, it is possible to operate at high dosage rates but to limited energy-dependent depth of penetration, the net effect being a shorter time of irradiation. Gamma rays, by contrast, have a high penetration capability at a relatively low dosage rate, and therefore large-area applications usually require a radiation time of several hours.

To reduce grain distortion while at the same time reducing surface discoloration, total energy input is advantageously between 10 and 100 kGy, preferably between 30 and 50 kGy. 1 Gy corresponds to 1 J/kg. More than 100 kGy provokes discolorations which are unacceptable on the customer side, particularly in the case of light-colored multi-layer sheet materials. An energy input between 30 and 50 kGy represents the optimum solution to resolving the conflict between discoloration and grain distortion. The total energy input referred to here may be brought about in one or more irradiation passes (irradiation cycles).

The multi-layer sheet material preferably has a gel content, as measured after 24 hours' extraction in boiling xylene, of from 10 to 70 wt %, preferably from 20 to 70% and more preferably from 30 to 60 wt %.

The sheet material of the present invention is very useful as an interior trim component for a vehicle, in particular for instrument panels, door trim, center consoles, parcel shelves, seat back walls, pillar trim and armrests.

The problem addressed by the present invention is further that of providing a method of producing a multi-layer sheet material having minimal discoloration and also reduced grain distortion.

The problem is solved by at least the following steps. A first step comprises producing the topcoat layer of plasticized polyvinyl chloride by a spread coating, calendering or extrusion process. At least one further step comprises producing further layers of the multi-layer sheet material, then at least one further step comprises combining the topcoat and further layers of the multi-layer sheet material, and at least one further step comprises lacquering and embossing the external surface of the topcoat layer. Then, a last step comprises radiation crosslinking the multi-layer sheet material by electron beam irradiation.

Two test examples were carried out in which a PVC laminate was partially crosslinked by radiation crosslinking at 30 and 50 kGy. The gel content of the PVC topcoat layer was 38 wt % and 46 wt %, respectively. The gel content referred to here is indicative of the degree of crosslinking. Discoloration after two weeks' aging at a temperature of 120° C. is found to be minimal on determination to DIN EN ISO 105/A02 at a gray scale grade ≧4.0 (a gray scale grade of 4.0 was measured in the case of a light color, e.g. light gray, higher values are achievable with darker colors). A radiation dose of 100 kGy produces some discoloration due to the degradation reactions of PVC, the gray scale grade here is equal to 3.0 in the case of a light coloring, while the gel content was 48 wt %. The maximum gel content to be achieved for a PVC formulation is 65 wt % assuming that the PVC and the crosslinking aids present crosslink to the max, since any plasticizers present do not crosslink.

This showed that the degree of grain distortion after thermoforming decreases with increasing degree of crosslinking. The grain looks more prominent in the drawn state. The effect of the crosslinking operation is to crosslink the polymer structure three-dimensionally. During thermoforming, therefore, the grain-distorting effect becomes more effectively dispersed throughout the entire sheet.

Test formulation of PVC topcoat:

100 phr of PVC (S-PVC, E-PVC and MS-PVC)

59 phr of plasticizer (DIDP)

2 phr of stabilizer (Ca/Zn)

3 phr of crosslinking aid (TMPTMA)

1 to 5 phr of pigments

The foam to be additionally used to construct the multi-layer sheet material was a 1.80 mm PP foam in the test example. The product was a PVC/PP (Yorn® light) laminate.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Also, in some example embodiments, well-known processes, well-known device structures, and well-known technologies are not necessarily described in detail.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

1.-10. (canceled)

11. A multi-layer sheet material having at least one topcoat layer of plasticized polyvinyl chloride and at least one outwardly facing layer of lacquer on the topcoat layer, wherein the topcoat layer of the multi-layer sheet material comprises from 50 to 100 wt % of at least one polyvinyl chloride, from 0 to 15 wt % of at least one crosslinking aid suitable for radiation crosslinking and a calcium hydroxide stabilizer and/or a Ca/Zn stabilizer having from 0.5 to 10 wt % of calcium and from 0.5 to 10 wt % of zinc, and wherein the multi-layer sheet material is radiation crosslinked.

12. The multi-layer sheet material as claimed in claim 11, wherein the polyvinyl chloride fraction in the topcoat layer is based on E-PVC and/or on MS-PVC.

13. The multi-layer sheet material as claimed in claim 11, wherein the amount of crosslinking aid is in the range from 0.1 to 10 wt %.

14. The multi-layer sheet material as claimed in claim 11, wherein the crosslinking aid is TMPTMA and/or TMPTA.

15. The multi-layer sheet material as claimed in claim 11, wherein the multi-layer sheet material further comprises at least one additional layer based on PVC and/or TPO.

16. The multi-layer sheet material as claimed in claim 15, wherein the additional layer is foamed.

17. The multi-layer sheet material as claimed in claim 11 used as an interior trim component for a vehicle.

18. An interior trim component for a vehicle, consisting of a multi-layer sheet material as claimed in claim 11.

19. A method of producing a multi-layer sheet material comprising:
providing a topcoat layer comprising plasticized polyvinyl chloride by a spread coating, calendering or extrusion process;
providing further layers of the multi-layer sheet material;
combining the topcoat and the further layers of the multi-layer sheet material;
lacquering and embossing an external surface of the topcoat layer;
radiation crosslinking the multi-layer sheet material by electron beam irradiation in a last step.

20. The method as claimed in claim 19, wherein electron beam irradiation is performed at an energy level between 10 and 100 kGy.

21. The method as claimed in claim 19, wherein the polyvinyl chloride fraction in the topcoat layer is based on E-PVC and/or on MS-PVC.

22. The method as claimed in claim 19, wherein the topcoat layer comprises crosslinking aid in an amount of from 0.1 to 10 wt %.

23. The method as claimed in claim 22, wherein the crosslinking aid is TMPTMA and/or TMPTA.

24. The method as claimed in claim 19, wherein the multi-layer sheet material further comprises at least one additional layer based on PVC and/or TPO.

25. The method as claimed in claim 24, wherein the additional layer is foamed.

26. The method as claimed in claim 19, wherein the multi-layer sheet material is used as an interior trim component for a vehicle.

27. A method of producing a multi-layer sheet material comprising:
providing a topcoat layer comprising from 50 to 100 wt % of at least one polyvinyl chloride, from 0 to 15 wt % of at least one crosslinking aid suitable for radiation crosslinking and a calcium hydroxide stabilizer and/or a Ca/Zn stabilizer having from 0.5 to 10 wt % of calcium and from 0.5 to 10 wt % of zinc;
providing further layers of the multi-layer sheet material;
combining the topcoat and the further layers of the multi-layer sheet material;
lacquering and embossing an external surface of the topcoat layer; and,
radiation crosslinking the multi-layer sheet.

28. The method as claimed in claim 27, wherein the topcoat layer is provided by a spread coating, calendering or extrusion process.

29. The method as claimed in claim 27, wherein radiation crosslinking the multi-layer sheet material is performed by electron beam irradiation.

30. The method as claimed in claim 29, wherein the electron beam irradiation is performed at an energy level between 10 and 100 kGy.
